(19) United States
(12) Patent Application Publication
(10) Pub. No.: US 2025/0245576 A1
(43) Pub. Date: Jul. 31, 2025

(54) SYSTEM AND METHOD FOR MITIGATING CATASTROPHIC FORGETTING

(71) Applicant: NICE LTD., Ra'anana (IL)

(72) Inventor: Danny BUTVINIK, Haifa (IL)

(73) Assignee: NICE LTD., Ra'anana (IL)

(21) Appl. No.: 18/428,565

(22) Filed: Jan. 31, 2024

(51) Int. Cl. G06N 20/20

(52) U.S. Cl. CPC G06N 20/20

(57) ABSTRACT

A system and method for mitigating forgetting in machine learning models may include or involve augmenting an input batch of real data items with synthetic data items, and generating, by a first machine learning model, a prediction for data items in the augmented batch—where the first machine learning model may be trained using a dataset of past synthetic data items. Some embodiments of the invention may include generating, by a second machine learning model, synthetic data items based on the input batch, where the second machine learning model may be trained using a dataset of past real data items. In some embodiments, generating predictions by the first machine learning model and the generating synthetic data items by the second machine learning model may be performed simultaneously or concurrently. A plurality of additional operations and procedures may be included in different embodiments to adjust or optimize the models' performance.

### FIELD OF THE INVENTION

The present invention relates generally to mitigating catastrophic forgetting in machine learning models, and particularly to mitigating catastrophic forgetting using synthetic data generated using generative artificial intelligence.

### BACKGROUND OF THE INVENTION

Artificial intelligence (AI) has propelled a new era in various scientific, technological, and industrial fields, offering unprecedented data analysis, automation, and predictive modeling capabilities. As AI systems become increasingly prevalent, a need for their continuous learning from, and adapting to, new data has become a fundamental requirement. In the broad domain of neural networks and cognitive computing, learning models should adapt and evolve as new data becomes available, e.g., in real time. This necessitates finding solutions to enable AI systems to learn sequentially without forgetting previous knowledge—a challenge that has been a significant bottleneck for deploying AI in real-world applications where data is ever-changing, and storage is finite.

### SUMMARY

Embodiments of the invention may mitigate or reduce forgetting, or loss of information, in machine learning models. Some embodiments may combine machine learning classification with generative artificial intelligence (GenAI) techniques to mitigate machine learning model forgetting and to enhance model incremental learning capabilities.

Some embodiments may augment an input batch of real data items with synthetic data items, and generate, by a first machine learning model, a prediction for data items in the augmented batch—where the first machine learning model may be trained using a dataset of past synthetic data items.

Some embodiments of the invention may generate, by a second machine learning model, synthetic data items based on the input batch, where the second machine learning model may be trained using a dataset of past real data items.

In some embodiments, generating predictions by the first machine learning model and the generating synthetic data items by the second machine learning model may be performed simultaneously or concurrently.

Some embodiments may include a plurality of additional operations and procedures, which may include various statistical analyses or inferences, for example to adjust or optimize the models' performance—which may include for example periodically retraining the relevant machine learning models, adjusting the number of data points or items in incoming or input batches, and the like.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows a high level architecture of an example system for mitigating catastrophic forgetting according to some embodiments of the invention;

FIG. 3 shows an example system for mitigating catastrophic forgetting according to some embodiments of the invention;

FIG. 4 shows an example input-output flow according to some embodiments of the invention;

FIG. 5 shows an example model training process according to some embodiments of the invention;

FIG. 6 illustrates a comparison of some example performance metrics according to some embodiments of the invention;

FIG. 7 shows a high level representation of an example process for mitigating catastrophic forgetting as embedded in an example system for fraud detection according to some embodiments of the invention;

FIG. 8 is a flowchart of an example fraud detection process according to some embodiments of the invention; and

FIG. 9 is a flow diagram of an example method for mitigating catastrophic risk according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

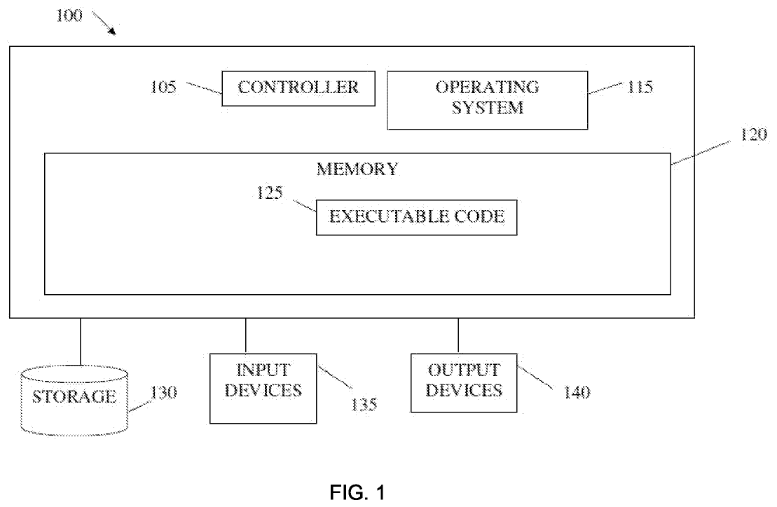

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or data such as low-level action data, output data, etc.

Executable code 125 may be any application, program, process, task, or script. Executable code 125 may be executed by controller 105 possibly under control of operating system 115. For example, executable code 125 may be or execute one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

Some embodiments of the invention may combine various tools and techniques from the fields of artificial intelligence (AI), machine learning (ML), and data science, e.g., in order to tackle or addressing the challenges faced in, for example, online incremental learning systems (see definition herein).

Online incremental learning as used herein may refer to a learning paradigm where a model may be continuously updated as new data arrives—without retraining the entire model from scratch. The corresponding model—which may be referred to herein as an “online model”—may learn incrementally when updating at least some of its parameters in response to each new data point (instead of, for example, updating all parameters in response to an entire dataset of new data points). As further discussed herein, some embodiments may provide a novel incremental learning approach for updating machine learning models by balancing the retaining old knowledge with acquiring new information.

Generative artificial intelligence (GenAI) models as used herein may refer to, for example, Generative Adversarial Networks (GANs) and/or Variational Autoencoders (VAEs), and/or additional or alternative machine learning models designed to generate or output new data points that may mimic the distribution of their training data. In some embodiments of the invention, GenAI models may be used to generate synthetic representations of past data, which may then be used for rehearsal and mitigating catastrophic forgetting such as, e.g., as further described herein. It should be noted that while specific GenAI models or model types, such as GANs and/or VAEs and/or combinations of such components, may be used in some example embodiments of the invention—additional or alternative GenAI models may be used in different embodiments, and GANs and/or VAEs should be considered nonlimiting examples.

“Catastrophic forgetting” as used herein may described or refer to the tendency of a machine learning model (such as for example an artificial neural network) to forget previously learned information upon the acquisition or the receiving or learning of new data or information, and/or following training and calibration using new data. Catastrophic forgetting may become particularly significant when, e.g., a model is sequentially trained as part of an execution of multiple (e.g., subsequent) tasks. This has been a fundamental problem, e.g., in neural network training-limiting the practicality of deploying machine learning models in environments where they must continuously adapt to new data streams. The problem of catastrophic forgetting is a core challenge in developing artificial intelligence systems, particularly those designed, e.g., for online incremental learning. When trained on a new dataset or task, a machine learning model may ‘overwrite’ the previously learned information, significantly deteriorating its performance on earlier tasks. This may be considered analogous to a student who, after cramming for a new exam, finds that the details of the previous subject studied are now fuzzy or entirely forgotten. As further described herein, some embodiments of invention may target this issue by employing generative machine learning models to simulate or represent previous learning experiences, or information prior to the most recent training of the relevant model, thus preserving earlier knowledge.

Generative replay as used herein may refer to a technique which may include or involve generating synthetic data which may describe or reflect a given model's previous training procedures or cycles, or previous states of knowledge. By interleaving, including, or mixing synthetic data with real, new data during training (which may be provided incrementally to an online model such as for example described herein), the model may maintain its performance on older tasks while learning new ones, such as for example further described herein. Some embodiments of the invention may leverage generative replay as a central mechanism for updating the learning model.

Synthetic data as used herein may refer to data points that may be artificially generated (e.g., by a machine learning model such as for example a GenAI model trained using historical or past data items or datasets, such as for example described herein) and that may not correspond to real-world observations or measurements (which may be referred to as “real data”)—but that can be used to mimic the characteristics of real data, for example by having statistical properties or characteristics similar to ones of real data. Various uses of synthetic data exist in different data analysis contexts, including, for example, generating synthetic data points for creating large enough datasets in cases only few real data points exist, and where some expected or desirable statistical properties for a larger, hypothetical dataset are known or assumed.

The implications of the problem of catastrophic forgetting are profound across various industries, and for example in fields such as financial crime (FinCrime) detection, where models should continually adapt to new patterns of fraudulent activity without losing the ability to detect older ones, due to adversaries constantly evolving their tactics. An artificial intelligence (AI) system for detecting fraud should be able to learn from the latest, most recent data, including for example transactions and threat alerts, without forgetting the characteristics of historical fraud patterns.

Consider, for example, a bank that has trained its system to recognize credit card fraud based on certain purchasing patterns and behaviors. The bank may update its fraud detection models with new data as criminals change their strategies. However, if, in doing so, the model forgets the patterns it learned before, the bank may become vulnerable to older methods of fraud that the model had previously learned to detect.

A financial institution may develop, for example, a machine learning model to identify money laundering schemes in another scenario. Such schemes may involve or be focused on, e.g., complex transaction layers or networks that obscure funds' illicit origins. As laundering techniques become more sophisticated, the institution's machine learning or AI model should learn to recognize new patterns. However, if the model cannot remember the signs of previously identified schemes, it could fail to catch repeat offenders or resurgent money laundering methods.

An inability to store and revisit all past data (which may be, for example, real data such as measured values, executed transactions, or medical documents for a given user and/or time period, e.g., all transactions involving user X during the month of February 1991) may exacerbate such issues. For example, due to storage limitations or privacy concerns, it may not be feasible or lawful for the bank or institution to keep all historical transaction data. This restriction becomes critical considering data privacy regulations, such as for example the general data protection regulation (GDPR), which may limit how much and how long personal data may be stored.

Furthermore, changes in data distribution and/or statistical properties over time, which may be referred to as concept drift, may mean or indicate that the nature of the data itself may change over time, which may make learning or inference by a machine learning model more difficult. In the example context of FinCrime, this may result from, e.g., changing customer behavior, new financial products, shifts in the socioeconomic landscape, and the like. If a machine learning or artificial intelligence model fails to adapt to such changes while retaining prior knowledge, its utility may diminish over time. In other words, concept drift as used herein may refer to data distribution changes such as, e.g., statistical properties of the data a model encounters, or data input to the model.

There is thus a need for robust methods to continuously update the model with new incoming data without losing the grasp of past data. This may prove particularly challenging in environments where new data arrives in streams, and where the model should be updated in real-time or near-real-time. Previous systems and methods for periodically retraining models with batches of data may not be suitable for such applications, as they can be too slow or computationally expensive or prohibitive.

In the particular, nonlimiting example of the FinCrime detection industry, such needs and problems may represent much more than a mere inconvenience—as they may pose a substantial risk: financial institutions are under immense pressure to keep up with regulatory requirements and to protect their customers from fraud. Failing to do so may have enormous, undesirable consequences, in terms of, for example immense financial loss as well as reputational damage.

Embodiments of the invention may propose or provide systems and methods that may adapt to changing data landscapes (such as for example ones handled in the context of online incremental learning) by, e.g., retraining auxiliary, generative models on the new or most recent data, which may support or enable a main machine learning model to maintain performance despite having to handle an evolving data landscape such as for example further described herein.

In this context, “new or most recent data” as used herein may refer to, for example, to data for a given time period (e.g., time period A) which has not (yet) been used to train or retrain a corresponding machine learning model (such as for example the online classifier model described herein), and therefore is not considered part of the “knowledge” included in that machine learning model—e.g., as opposed to “past data” generated during a different time period (e.g., an earlier time period B) which has been used in training or retraining the model.

Based on, for example, some or all or the protocols and procedures discussed herein, some embodiments of the invention may allow a machine learning model such as, e.g., an online incremental learning model to maintain and/or enhance or improve its performance, adaptability, and robustness.

Some embodiments of the invention provide a novel framework for mitigating catastrophic forgetting using generative AI models to simulate and “rehearse” past learning, thereby retaining a continuum of knowledge—or knowledge reflecting or corresponding to more than just a single training cycle or procedure. Generative models, such as Generative Adversarial Networks (GANs) and/or Variational Autoencoders (VAEs), or combinations of such models, may act or serve as a memory component for the system, for example by generating synthetic data representative of previously encountered or used information. This synthetic data is then used to reinforce or rehearse “old” knowledge (e.g., knowledge which existed prior to receiving new data or information) in the learning model, which may thus prevent an undesirable overwriting or forgetting of valuable information as new data is learned. Embodiments may circumvent the need for extensive data storage and may address privacy concerns, as the actual past or historical data may not be kept or retained.

In some embodiments of the invention, a conditional variational autoencoder (CVAE) or encoders (CVAEs) may be used as a VAE component in the generative model, which may allow using or considering statistical properties of past or historical data in generating synthetic data. CVAEs may be conditioned in conjunction with past data or knowledge such that, e.g., outputs generated for a given input may not only represent or describe that input—but also a plurality of past data elements and their statistical properties and/or a statistical distribution or distributions.

In this context, embodiments may include an encoder subcomponent of the VAE which may receive a data point or a real transaction (see further description herein) as an input and return a probability or statistical distribution of a latent space (and/or, e.g., parameters of Gaussians describing or representing statistical properties of the latent space) as an output. A decoder subcomponent may then receive the distribution produced or generated by the encoder and produce a synthetic data point or output based on the distribution. In some embodiments, the encoder and decoder components may be separate and distinct neural networks, each composed of a plurality of appropriate neural layers. Some embodiments may include or involve training the encoder using past of historical data (such as for example real transactions and/or batches of real transactions), and training the decoder using past or historically generated statistical distributions (which may be or may include, e.g., parameters of Gaussian functions and/or additional or alternative statistical parameters previously generated by the encoder).

In such manner, encoder and/or decoder subcomponents of, e.g., a VAE may be used in learning a distribution of a dataset, (or of an updated dataset of past real data items—such as for example described herein), and in training or retraining a machine learning model (such as, e.g., the second machine learning model or GenAI model or component further described herein) based on the learned distribution. It should be noted that various VAE systems, as well as training schemes for different subcomponents such as for example described herein may be included and/or used in different embodiments of the invention. In some embodiments of the invention, CVAE components may include using additional inputs or “conditions”, e.g., for generating synthetic data in a conditional manner. Some nonlimiting example conditions may be or may include, e.g.:
Time periods: some embodiments may condition synthetic data generation using characteristics of specific time frames or periods, such as for example yearly quarters, seasons, or months. For example, in a case where the data patterns are known to be season or time-dependent, embodiments may condition synthetic data generation based on appropriate characteristics for that time (synthetic transactions relating, e.g., to electricity bills during winter months may be conditioned to have a higher average transaction value compared to, e.g., the average of real electricity bill related transactions taking place during the summer).
Event markers: in an example case where there are assumed or known events or changes to the system being described by the data (e.g., a policy change, an expected economic event such as for example a global crisis), some embodiments may use corresponding variables or parameters as conditions to generate synthetic data corresponding to such events (e.g., requiring synthetic transactions to have lower average values than, e.g., transactions that would have been generated based purely on VAE training).
Data distribution parameters: some embodiments may use statistical characteristics of historical data batches, or of specific batches among a plurality of batches, as conditions for VAE based synthetic data generation. Characteristics and/or parameters may be or may include, e.g., mean and/or variance as well as more complex distributional parameters of a given batch or data point.
Labels or categories: in a case where the data has distinct types, categories or labels (such as for example customer segments, product types, or transaction categories—see also further discussion herein)—these may be used as conditions in some embodiments of the invention.
   In one nonlimiting use case example, transaction data may be considered for an online retailer. Some embodiments may use a given month, a given type of product, or a transaction value or amount as conditions for conditionally generating synthetic data more closely resembling the corresponding conditions. In case, e.g., it may be desirable to generate synthetic data that resembles or corresponds to transaction patterns typically seen in November (perhaps to prepare for Black Friday or Cyber Monday), some embodiments may include conditioning the VAE or CVAE subcomponent using real data previously obtained the month of November throughout past years. It should be noted that additional or alternative conditioning schemes may be used in different embodiments of the invention.

Embodiments of the invention may create or generate new or synthetic data points that may be statistically similar to an original, reference dataset—which may be, e.g., a dataset used for training the model at an earlier point or points in time—and which may enable a machine learning model to maintain performance on older tasks while continuing to acquire or receive new information.

In this context, at least some embodiments of the invention may operate under, or conform to, strict privacy regulations where, e.g., data may be sensitive—such as for example in medical or financial fields. The ability to generate representative synthetic data without storing actual past data may be desirable, e.g., for maintaining compliance with privacy laws and regulations such as mentioned herein, and as such may constitute one technological improvement among many that may be provided by different embodiments of the invention.

In some contexts and/or dynamic data landscapes where data distributions and/or statistical properties may change rapidly (e.g., landscapes exhibiting non-negligible concept drift)—a given system's capacity to adapt to changes may prove vital. Generative models included in some embodiments discussed herein may thus be retrained periodically to adapt to, or to reflect, the most current or recently received data—which may allow or enable machine learning models to maintain their relevance and/or accuracy over time and resist failures relating to changes in data distributions over time.

Some embodiments of the invention may include or use a specific type of machine learning models for online incremental learning (which may for example be considered as the “main” model, or the “online incremental learning” model, or simply “online model”—which may be used, e.g., to solve a classification problem such as, e.g., determining whether a transaction may be fraudulent).

An example incremental machine learning model which may be used in some embodiments of the invention may for example be a model optimized using a stochastic gradient descent (SGD) algorithm and a logarithmic loss function. Such model or model type may be referred to herein as “SGDClassifier” or “SGDClassifier with Log Loss”, and some embodiments may use this model or classifier to implement the generative replay mechanism as further described herein. It should be noted, however, that additional or alternative machine learning models or classifiers may be used in different embodiments of the invention, and that the SGDClassifier (which may be used in a supervised or unsupervised forms) should be considered a nonlimiting example.

An appropriate procedure or method such as for example the “partial_fit” method known in the art may allow for incremental updates to the online SGDClassifier model, making it suitable for online learning and classification scenarios or purposes. Additional or alternative model methods and/or frameworks for online incremental learning are, however, known in the art and may be used in different embodiments.

Evaluation metrics such as, e.g., further discussed herein may be used to quantify or assess the performance of the online model, for example both with and without the replay mechanism. Some embodiments may provide a comparative analysis of such metrics, e.g., in order to demonstrate the efficacy of the proposed solution and/or to automatically fine tune different model or batch parameters such as for example further described herein.

Replay ratio and batch size as referred to herein may be parameters which may determine the proportion of synthetic data vs. real data used during training and/or the total number of data points processed. One skilled in the art of machine learning and GenAI may recognize that various parameter values may be selected and/or used in different embodiments, and that some embodiments of the invention may include or involve optimizing parameters such as for example replay ration or batch size to achieve desirable performance (and, e.g., balance learning new information and retaining old knowledge in an effective manner) and/or computational cost scaling properties. In this context, various optimization strategies and protocols are known in the art and may be used in different embodiments of the invention.

Additionally, and as known in the art of machine learning and GenAI, some embodiments may further include architectural enhancements or additions to the GenAI models—such as for example enhancements to the generator and/or discriminator components of a GANs, which may correspond, e.g., to expanding relatively simplistic generative models (including for example a single or a few hidden layers) into more complex structures that may involve multiple layers of varied sizes and/or activation functions. Some such modifications may for example increase the synthetic data's quality, which may prove beneficial for the system's ability to effectively remember and replay past data scenarios. Similarly, various different hyperparameters and optimizers may relate to settings and algorithms used to control the learning process of, e.g., the generative models considered herein. Some embodiments of the invention may consider or use different selections and tuning processes for such parameters, for example in order to optimize the computational cost and/or performance of the generative models within the system. Various relevant machine learning or neural network parameter optimization strategies and protocols for GenAI models are known in the art and may be used in different embodiments of the invention.

Some example optimization strategies which may improve model performance may include, for example, adjusting the learning rates and responsiveness of relevant optimizers; modifying or adjusting the number of epochs or training cycles for GAN and/or VAE training, for example in order to refine or adjust synthetic data generation; and/or modifying or adjusting the replay ratio to find an optimal balance between learning from historical synthetic data and new real-time data—such as, e.g., further described herein with regard to calculated performance metrics. Additional or alternative optimization strategies, including additional or alternative operations, may be used in different embodiments and may be valuable for fine-tuning the system's performance to industry-specific applications, such as the nonlimiting example of FinCrime detection discussed herein.

Some embodiments of the invention may enable or provide desirable production integration capabilities. For example, in some production environments, a desirable mode of operation may involve real-time processing of incoming data streams by the online model concurrently, or in parallel to, the GAN and/or VAE generating synthetic data to augment the training set such as for example described herein. This may ensure that the relevant machine learning models constantly or continuously learn from both real and synthetic data, which may allow improving its predictive accuracy and decision-making capabilities. As further discussed herein, some embodiments may thus provide a continuous improvement mechanism, where a machine learning model such as for example an online model may be perpetually or constantly updated with a blend or mixture of real and synthetic data. This process may allow for real-time adaptability to changing data patterns, which may ensure the model remains updated and effective in dynamic environments where, for example, fraud patterns and financial crimes change or evolve swiftly.

Model training or retraining mechanisms, protocols and procedures on new and/or synthetic data are further described and discussed herein and may be vital to maintaining the quality and relevance of newly generated synthetic data. As further noted herein, a need for retraining may arise due to data drift, but also for additional or alternative reasons such as ones involving or relating to, e.g., model degradation, concept drift, improvements in data quality, and/or algorithmic advancements. Retraining on a regular basis, such as for example further described herein, may ensure, for example, that the generative performance of the relevant machine learning models—such as for example the GAN and/or VAE—does not wane or deteriorate and that the remembering mechanism remains effective in mitigating, or in critically reducing the risk for, catastrophic forgetting.

In some embodiments of the invention, the GenAI model or model components (such as, e.g., GAN, VAE, or a combination of the two) may be retrained on a regular basis and provide a machine learning model such as, e.g., the SGDClassifier online incremental learning model, with robust and meaningful synthetic data, e.g., by adapting to new data patterns and diverse data landscapes such as for example further described herein. This may enable the model to continue its continual learning process, which as noted herein may be crucial for applications where the temporal relevance of data is paramount, such as in nonlimiting example use cases of, e.g., financial markets or social media trend analysis using machine learning models.

Embodiments of the invention may thus be designed to maintain high performance in evolving data landscapes. It may be particularly viable in, or suited for, fields requiring acute sensitivity to data patterns, such as for example financial crime detection, although additional or alternative fields and contexts may be realized. Through innovative use of generative AI models, some embodiments of the invention may set a new standard for AI systems' continual learning capabilities.

It should be noted that the FinCrime detection examples should be considered nonlimiting, as one skilled in the art would recognize that different embodiments of the invention may be used in various fields and/or technological contexts unrelated to fraud detection and/or finance (such as for example in medical contexts, which may also include or involve discarding private data due to privacy regulations—although various additional or alternative use cases may be realized by one skilled in the art of GenAI and machine learning).

As further discussed herein, some embodiments of the invention may be implemented or embedded in existing systems for, e.g., FinCrime detection, such as transaction monitoring software and/or platforms; data items other than transactions may be used in other embodiments. In the present document, the IFM-X fraud management platform by NICE Actimize Ltd. may be considered a nonlimiting example FinCrime detection system in which some embodiments may be implemented. One skilled in the art, however, would realize that various platforms and/or environments may be used in different embodiments.

In accordance with some of the discussions herein, an example algorithmic flow for mitigating catastrophic risk according to some embodiments of the invention may be, e.g.:

### Example Algorithm 1

Input: batch of transactions (or other data items)
Output: batch of transactions with predictive scores per transaction

| | |
|---|---|
| 1. | Perform initial preprocessing on the input batch |
| 2. | Store preprocessed (“real”) batch in the database |
| 3. | Send the batch to the GenAI model and send real batch to |
| | integration component |
| 4. | Get synthetically generated (“synthetic”) batch/batches from the |
| | GenAI model |
| 5. | Integrate real batch with synthetic batch |
| 6. | Send integrated batch to online SGDClassifier |
| 7. | Get predictive scores per transaction |
| 8. | Verify and validate the scores with using a pre-defined threshold |
| 9. | If the score is above the predefined threshold - classify transaction |
| | as suspicious and/or send an alert corresponding to a |
| | suspicious transaction |
| | Else (If the score is below the threshold) - do nothing. |

Different steps in Algorithm 1 are further discussed and explained herein. It should be noted that additional or alternative process workflows or algorithms may be used in different embodiments of the invention.

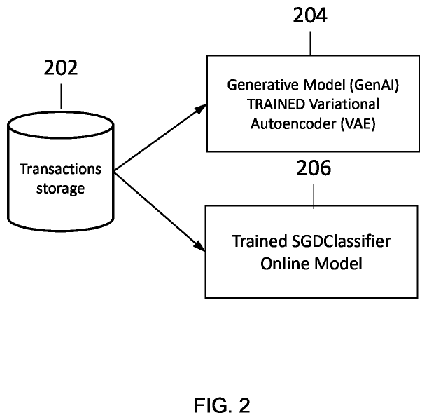

FIG. 2 shows a high level architecture of an example system for mitigating catastrophic forgetting according to some embodiments of the invention.

As further described herein, some embodiments may include inputting batches of data points such as for example credit card transactions from a database such as, e.g., transaction storage 202 (which may include or be described using a plurality of transaction variables or parameters such as, e.g., described herein), into two machine learning models or components, such as for example GenAI GAN and/or VAE component 204 and SGDClassifier online model component 206. Components 204 and 206 may be trained using either/both real and synthetic data points, batches, or datasets, such as, e.g., further described herein.

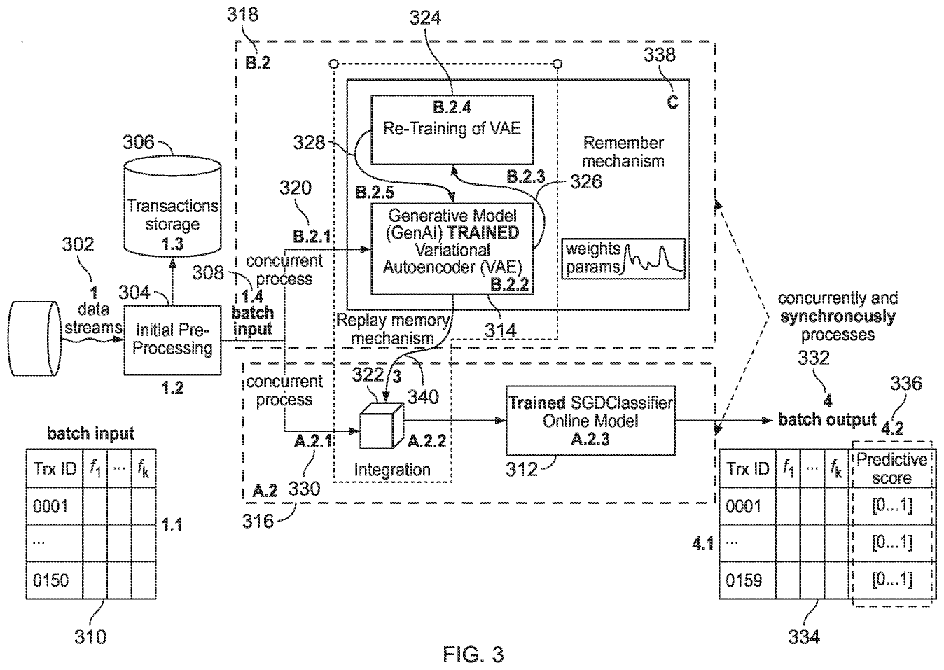

FIG. 3 shows an example system for mitigating catastrophic forgetting according to some embodiments of the invention.

Some embodiments of the invention may include a first machine learning model (such as for example an SGDClassifier online model) and a second machine learning model (such as for example GenAI GAN and/or VAE model)—where each model performs different operations and/or functions such as for example described herein. Machine learning models using in different embodiments of the invention may be or may include different neural networks such as deep neural networks, convolutional neural networks, and/or additional or alternative neural network or machine model architectures as known in the relevant arts.

Data streams (1) 302 may be received or arrive (e.g., in real time) at the online machine learning GenAI system and go through a standard or initial pre-processing step (1.2) 304. In some embodiments, preprocessing may be or may include filtering data points or transactions according to custom events and/or tags or activities such as for example further described herein—and/or formatting or organizing the data into a predetermined format (such as for example a table), and/or cleaning the data or removing irrelevant parameters or entries. Additional or alternative steps or protocols for preprocessing are known in the art and may be used in different embodiments of the invention. Pre-processed data points (such as for example transactions) may be stored in a database (1.3) 306 and be input into or rerouted to the central components of the system including the ML models.

Incoming data or batch input (1.4) 308 may represent batches of preprocessed transactions (1.1) 310, for example in a predetermined format, such as, e.g., a table including a plurality of transactions, where each transaction described by a plurality of transaction parameters or variables such as for example further described herein.

Each batch of transactions may include or contain a pre-defined or predetermined number of transactions. In some embodiments, the number of transactions which may be selected or included in a batch may not play a direct role in, or be orthogonal or agnostic to, subsequent machine learning related processes—although it should be noted that the number of transactions per batch may influence or impact, e.g., the performance or computational cost considerations (including for example both those related to the online incremental machine learning model SGDClassifier (A.2.3) 312 and GenAI model (B.2.2) 314).

In some embodiments of the invention, generating predictions by a first machine learning model (such as, e.g., SGDClassifier (A.2.3) 312) and the generating synthetic data items by the second machine learning model (such as, e.g., GenAI model (B.2.2) 314) as further described herein may be performed concurrently.

Some embodiments of the invention may include two concurrent and synchronous flows, such as, e.g., flow A.2 316 and flow B.2 318. A.2 316 may be a flow for an online ML model (such as for example a SGDClassifier model 312 such as, e.g., described herein) to provide predictions per each transaction in an input batch of transaction based on the previous training stage (see further discussion herein). Flow B.2 318 may generate synthetic data based on the incoming batch (B.2.1) 320, which may be, e.g., the batch input to the system in (1.4) 308. Embodiments may include another machine learning model component B.2.2 314 may be for example a GenAI component (such as, e.g., the VAE and/or GAN models discussed herein), which may learn or be trained using underlying statistical properties and/or distributions of an incoming batch of transactions and/or using a plurality of historical data items, and may generate synthetic data that may be very close to, or statistically representative to the original, “real” batch input to the system (e.g., the batch of in (1.4) 308)—see, e.g., discussion herein regarding the encoder and decoder subcomponents and their functionalities and/or training schemes. Embodiments may then pass or send the generated synthetic data (3) to component A.2.2 322, which may integrate real and synthetic data, for example into a single batch. As further discussed herein, such integration according to some embodiments may minimize or mitigates catastrophic forgetting for a machine learning model such as, e.g., the online SGDClassifier model (A.2.3) 312.

Some embodiments of the invention may include generating, by a second machine learning model—which may include for example a generative adversarial network, and a variational autoencoder, such as, e.g., included and described with regard to GenAI GAN and/or VAE component 314—synthetic data items based on an input batch such as for example described herein. In some embodiments, the second machine learning model may be trained using a dataset or datasets of past real data items or batches of such items such as for example described herein. Some embodiments of the invention may include learning a distribution of an updated dataset of past real data items, and retraining the second machine learning model based on the learned distribution—such as for example described herein regarding the encoder and decoder subcomponents and their functionalities and/or training schemes.

As discussed herein, model (B.2.2) 314 may generate synthetic data based on for example the incoming “real” batch and based on historical data from (1.3) 306. In this context, in some embodiments of the invention, it may not be enough for model (B.2.2) 314 to generate synthetic data while relying only on the incoming batch (B.2.1) 320 (which may be, e.g., the same batch considered in 1.4 308), e.g., because such incoming batch may be statistically unrepresentative of previous or historical data, and may represent only a small fraction of the data the system is trying to describe or predict. Consequently, model B.2.2 314 may be trained or pre-trained using appropriate data volumes from the past, or using historical data or dataset (1.3) 306, and may accordingly perform synthetic data generation according to its trained parameters, and according to learned statistical properties or distributions of historical data such as for example discussed herein regarding encoder and decoder subcomponents. As time passes, the training or knowledge of model (B.2.2) 314 may become less relevant or have less predictive value—e.g., since new data received by the system may differ or contain shifts in its properties and/or statistical distributions (e.g., as discussed herein with regard to data drift), which might lead, for example, to generating statistically irrelevant or inaccurate synthetic data having no desirable predictive value. To address or resolve this problem, component (B.2.4) 324 may thus be or include a re-training process or procedure for model B.2.2 314—which may include receiving or fetching new or updated data from database (1.3) 306, and training or retraining model B.2.2. 314 based on the most recent or updated statistical properties or distributions such as for example described herein. In some embodiments, training flows used for retraining protocols or procedures may be different than flows used for initial training. As noted herein, various training flows are known in the art and may be used in different embodiments.

Flows B.2.3 326 and B.2.5 328 may indicate a recurrent or looped process of re-training B.2.2 324 according to some embodiments of the invention. A re-training process may happen or take place occasionally or periodically, for example based on a predetermined or default time period for retraining (such as, e.g., every 1 hour, 1 day, etc.), and/or based on a decision or request by a human analyst or subject matter expert (SME), and/or automatically—for example upon the detecting of degradation in the system's overall performance (which may be performed, for example, by comparing results obtained with or without a retraining mechanism such as for example further described herein).

In some embodiments, flow A.2 316 may get or receive incoming processed batch (1.4) 308 concurrently to flow B.2 318 (as shown in FIG. 3, incoming processed batch (1.4) 308 may “become” A.2.1 330 when it enters the flow A.2 316; this, however, may be a purely semantic issue which may represent no change in numbers, logic, or data). Incoming processed batch (1.4) 308 may then proceed to component A.2.2 322, and for example be integrated with generated synthetic data. The integrated data may then proceed to the online incremental machine learning model SGDClassifier (A.2.3) 312.

Some embodiments of the invention may include generating, by a first machine learning model (such as for example SGDClassifier (A.2.3) 312), a prediction for each data item in a batch of data items—which may be a batch augmented e.g., such as for example described herein (which may also be referred to as an augmented batch). In some embodiments, the first machine learning model trained using a dataset of past synthetic data items.

SGDClassifier (A.2.3) 312 may perform or generate predictions—which may include, for example, calculating or outputting predictive scores—per each data point or transaction in the batch, including both real and synthetic data points or transactions. Predictions on synthetic transactions may be subsequently removed or discarded from the output or “batch output” 4 332 provided by the system, which may be or may include a list or table of predictions 4.1 334 and/or scores 4.2 336 for relevant transactions.

In some embodiments of the invention, all parameters of the online SGDClassifier model may be trained, calculated or learned on synthetic transactions (which may for example be generated using the GenAI model and represent past knowledge such as, e.g., described herein). SGDClassifier parameters may thus continue to influence or impact subsequent predictions, e.g., on next or additional or subsequent batches of transactions. In such manner and as further discussed herein, the memory of previously learned transactions by A.2.3 312 may be preserved, and catastrophic forgetting may be mitigated. Training of machine learning models such as, e.g., the online model may include additional or alternative data points and/or data sources (including, e.g., real transactions, synthetic transactions, or a blend of the two) in different embodiments of the invention.

Subsystem C 338 may depict, denote, or mark the remembering mechanism, which may comprise the two parts of the GenAI (e.g., VAE and/or GAN) component B.2.2 314 and retraining mechanism B.2.4 324.

Some embodiments of the invention may include augmenting an input batch of real data items with synthetic data items.

For example, component A.2.2 322 may be referred to herein as an integration component or as a synthetic data integration system (SDIS). The SDIS may be at the confluence of the two, or dual pathways within the system (e.g. one pathway of receiving outputs from the GenAI model to allow the replay mechanism 3 340 and another pathway for receiving input data or input batches 1.4 308 or subflow A.2.1 330), and may thus allow for combining the real-time processed transaction data with the synthetic data generated by the GenAI component. The SDIS may function on a principle of balanced data augmentation, where it may ensure the predictive continuity of the online machine learning model and enrich or extent the training set with synthetic data points, e.g., to preserve impact of historical data, such as for example described herein (see also, e.g., Algorithm 2 herein).

The SDIS may operate by accepting inputs from multiple primary sources including, e.g.: the incoming batch of transactions (1.4) 308 and the synthetic data stream from stream 3 340. In some embodiments, inputs may be received from multiple sources in a simultaneous or concurrent manner. As real or real-time transactions or batches of transaction are being input to the SDIS, they may immediately be complemented or augmented (e.g. have added to) with an equivalently structured set of synthetic transactions generated by the GenAI model.

In some embodiments, augmenting batches of data points or transactions may include, for example, if each synthetic data item corresponds to a plurality of statistical properties, adding the synthetic data item to the augmented batch, where the statistical properties may describe the input (or pre-augmented) batch—and otherwise, if a given synthetic data item does not correspond to the relevant statistical properties, not adding the synthetic item to the batch or discarding the item. Some embodiments of the invention may include mapping a correspondence between each synthetic data item and real data items in the input batch, and adjusting the augmenting of the input batch based on the mapping and based on, e.g., a dataset of past synthetic data items, and a dataset of past real data items.

In some embodiments, the synthetic transactions may be generated, or constructed to mirror, reflect, or describe the statistical properties of the incoming batch and the historical data, which may thus provide an adequate representation of the relevant data landscape—such as for example discussed herein with regard to encoder and decoder subcomponents of VAE.

The SDIS may be tuned or engineered to recognize and map the correspondences between the real and synthetic batches or datasets, ensuring that each synthetic transaction generated may accurately reflect what the system has learned in previous training cycles. Such mapping may not be merely a duplication but an intelligent synthesis that may consider shifts in data distributions, emerging patterns, and latent correlations essential for maintaining the integrity of the model's knowledge base.

In some embodiments, the SDIS may determine the optimal ratio and selection criteria for synthetic data integration. This may be achieved through a dynamic (e.g., automated, real time) analysis of the model's performance metrics such as for example described herein, and/or a manual SME's input, e.g., concerning model performance, data relevancy and/or distribution shifts, and the like. The SDIS may provide a tailored, tunable augmentation of the training set for the SGDClassifier, which may ensure that the model is continuously learning and adapting without discarding the valuable insights gained from past data—such as for example described with reference to Algorithm 2 herein.

The SDIS may thus act as a dynamic memory facilitator within the GenAI system. It may leverage the generative capabilities of the VAE to produce a synthetic dataset that may act or serve as a “bridge” connecting the past and present knowledge of the system. This bridging ensures that as the SGDClassifier evolves with, or learns new data, it may still retain a foundational understanding of historical patterns, thereby preserving its ability to detect and predict across a spectrum of scenarios, including both old and new problems.

The impact or importance of the SDIS may be manifold. In the nonlimiting example context of FinCrime detection, it may enable the online model to be vigilant and accurate across varying fraud tactics. Thus, even when considering new, sophisticated fraud schemes, the model may remain sharp and effective when used on both old and new problems: for the resurgent or modified versions of older schemes, the model's memory, facilitated by SDIS, may allow for quick recognition and response.

An example algorithmic flow for synthetic data integration (e.g., by the SDIS) according to some embodiments of the invention may be, e.g., Example Algorithm 2:

Input: Real-time transactions batch (realBatch), Synthetic transactions
(syntheticBatch)
Output: Augmented data set for training the SGDClassifier

| | |
|---|---|
| 1. | initialize augmentedBatch as an empty list |
| | //Accept incoming real-time transaction batch |
| 2. | for each transaction in realBatch: |
| 3. | add transaction to augmentedBatch |
| | //Accept incoming synthetic transaction batch |
| 4. | for each syntheticTransaction in syntheticBatch: |
| | //Ensure synthetic transactions mirror real data properties |
| 5. | if syntheticTransaciton matches the statistical properties |
| | of realBatch: |
| 6. | Add syntheticTransaction to augmentedBatch |
| | //Map correspondences and integrate real and synthetic data: |
| 7. | for each transaction in augmentedBatch: |
| 8. | if transaction is synthetic: |
| 9. | map correspondence to real data in realBatch |
| 10. | adjust transaction to reflect learned historical pattens |
| | //Calculate and analyze performance metrics and/or SME |
| | input for data relevancy |
| 11. | optinalRatio <- determine |
| | OptimalIntegrationRatio(performanceMetrics, SMEinput) |
| 12. | augmentedBatch <- applyOptimalRatio(augmentedBatch, |
| | optimalRatio) |
| | //Prepare data for SGDClassifier training |
| 13. | for each transaction in augmentedBatch: |
| 14. | if transaction is synthetic: |
| 15. | prepare transaction for SGDClassifier training |
| 16. | else: |
| 17. | continue with real transaction preparation |
| | //Return the augmented data set |
| 18. | return augmentedBatch |

As further discussed herein, various performance metrics may be used as part of different embodiments of the invention and, in particular, as part of Algorithm 2. It should be noted that additional or alternative process workflows or algorithms may be used in different embodiments of the invention.

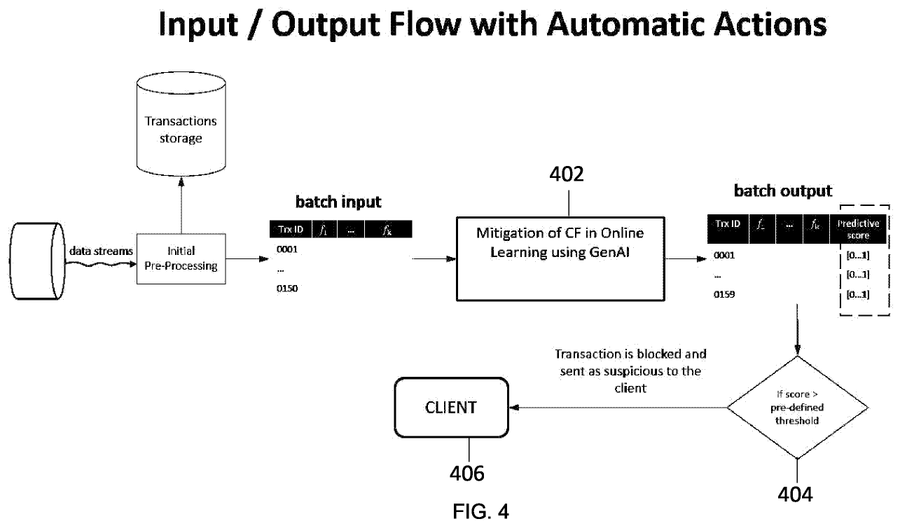

FIG. 4 shows an example input-output flow according to some embodiments of the invention.

In some embodiments of the invention, a prediction generated for a given data point or transaction (such as for example performed for data points in batches, by the online model, such as, e.g., described herein) may include a predictive score, such as for example known in the art of machine learning based classification.

Some embodiments of the invention may perform or execute automated actions based on calculated scores. Some embodiments may include, for example, transmitting an alert to a remote computer system over a communication network if a score exceeds a corresponding threshold (and if not—e.g., do nothing).

As discussed with reference to FIG. 3, following the mitigation of catastrophic forgetting 402 (using, for example, components, subsystems and flows such as described herein), and the calculating of predictive scores by the online model, embodiments of the invention may check if the score for a given transaction exceeds a predetermined or predefined threshold 404. In the nonlimiting example of FinCrime detection, if the score exceeds that threshold, some embodiments of the invention may automatically block or deny the relevant transaction and/or prevent it from being executed, and may for example send or transmit, over a communication network, a notification or alert to a remote computer system or client 406 (which may be, e.g., a mobile phone or computer system operated by a credit card owner) that a suspicious transaction has been found or detected. If the score does not exceed the relevant threshold, embodiments may, for example, not take any action, or do nothing. Various frameworks for sending or transmitting of various notifications or alerts, and for performing various additional or alternative automated actions (e.g., ones unrelated to FinCrime or to financial transactions), are known in the art may be included in different embodiments of the invention.

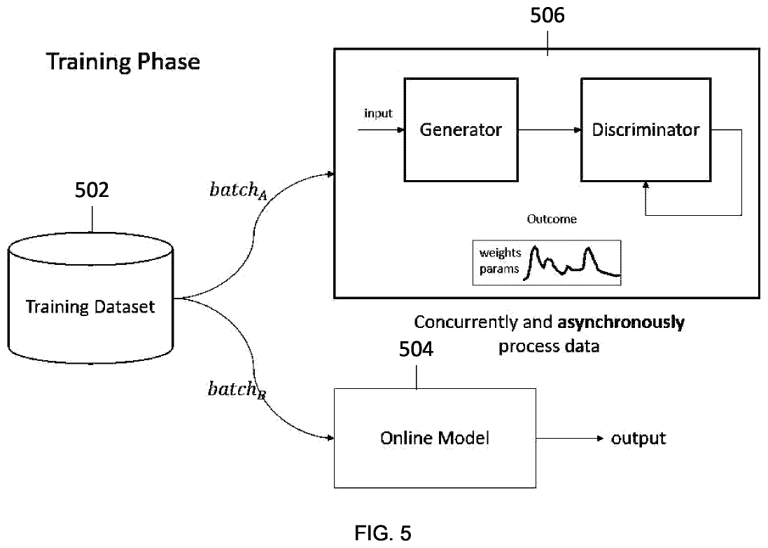

FIG. 5 shows an example model training process according to some embodiments of the invention. Consider, e.g., a database or dataset 502 with historical data being received constantly (e.g., in real time), in streams. Streamed data may be pre-processed, such as for example described herein, before being input into an online machine learning system or online model 504. Data stored in the database or included in dataset 502 may be preprocessed, for example, to filter specific data points from an initial set of datapoints or transactions.

Embodiments may include two sub-systems: the online machine learning model 504; and a GenAI model 506 which may be or may include Generative Adversarial Networks (GANs; which may for example include generator and discriminator components as known in the art), and/or the Variational Autoencoder (VAE) neural network model, such as, e.g., described herein.

In some embodiments, the online Incremental SGDClassifier model may receive different subsequent batches, or batch by batch, from a training dataset or datasets 502. Each batch may contain, for example, a pre-defined number of data points or transactions (e.g., 150 transactions per batch). Processing transactions in batches may enable the model's training to balance allowing high granularity (which may be achieved for example by including only a few transactions in each batch) and considering a large volume or overall number of transactions. As noted herein, batch parameters may affect the precision and/or accuracy of trained online incremental learning and computational cost of the training process, and different choices or various parameters such as for example batch size may be used in different embodiments of the invention.

Some embodiments of the invention may include, prior to the generating of a prediction for data items (e.g., in batches or augmented batches such as for example described herein), training the first machine learning model (e.g., the SGDClassifier model described herein), e.g., until a minimum required performance level is achieved.

The online incremental model SGDClassifier may be tested, for example on a test dataset (which may be or may include dataset 502). If the results or predictions meet the initial requirement of model performance (e.g., according to performance metrics such as for example described herein), then the training process may stop or end. If not, the training process of SGDClassifier may proceed or continue on additional batches—which for example may be or may include permutations on previous batches used in training, or batches that contain different transactions than before, or transactions not included in previous batches: For example, if a given batch (such as for example batch 1, denoting the first batch input to the model) contains transactions A, B, C, and D, then in a new iteration training process, that batch might have transactions A, E, C, and F. In some embodiments, the size or number of transactions in batches may be constant and may not change from batch to batch within a single training cycle or iteration—while batch size may change from one training iteration to another, and for example until SGDClassifier exhibits required performance. Additional or alternative training operations and/or constraints on various batch related parameters may be realized and included in different embodiments of the invention.

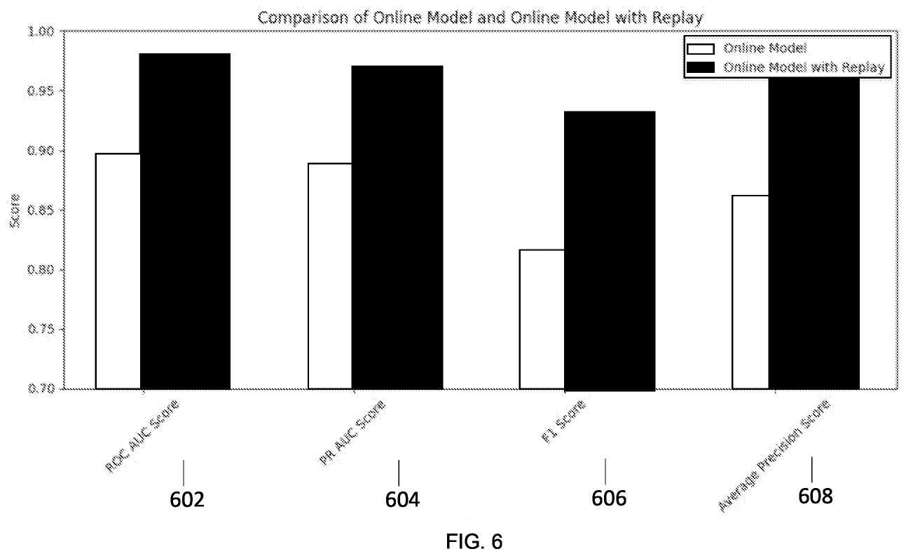

FIG. 6 illustrates a comparison of some example performance metrics according to some embodiments of the invention.

Some performance metrics that may be used in some embodiments to assess or quantify performance may be or may include, for example: a receiver operating characteristic area under curve (ROC AUC) score 602; a precision recall area under curve (PR AUC) score 604; an F-score or balanced F-score (F1) 606; and an average precision (AP) score 608, although additional or alternative scores for classifier performance assessments are known in the art and may be used in different embodiments.

It can be seen that in the example considered, incorporating replay into the online model significantly enhances performance across all evaluated metrics 602-608. The online model with replay exhibits consistently higher scores, indicating improved classification, ranking, and accuracy compared to a basic online model, or to a model not including a replay mechanism such as for example described herein. These findings suggest that incorporating replay mechanisms into online models may be a valuable strategy for improving their performance and robustness in real-time applications.

Some embodiments of the invention may calculate various performance metrics (such as for example metrics 602-608 and/or additional or alternative metrics) in an automatic and periodic manner (for example, every 1 hour, day, etc.), and adjust various batch and/or model parameters according to the calculated metric values. For example, if a calculated performance metric such as for example the F or F1 score for the online model is below a predetermined threshold (of, e.g., a score of 0.5), embodiments of the invention may automatically increase the size of the training set or batch used in training the relevant machine learning, and/or increase the frequency or number of retraining cycles per period (e.g., from 3 cycles per hour to 4 cycles per hour). Additional or alternative automated actions performed by different embodiments of the invention based on calculated performance metrics may be realized.

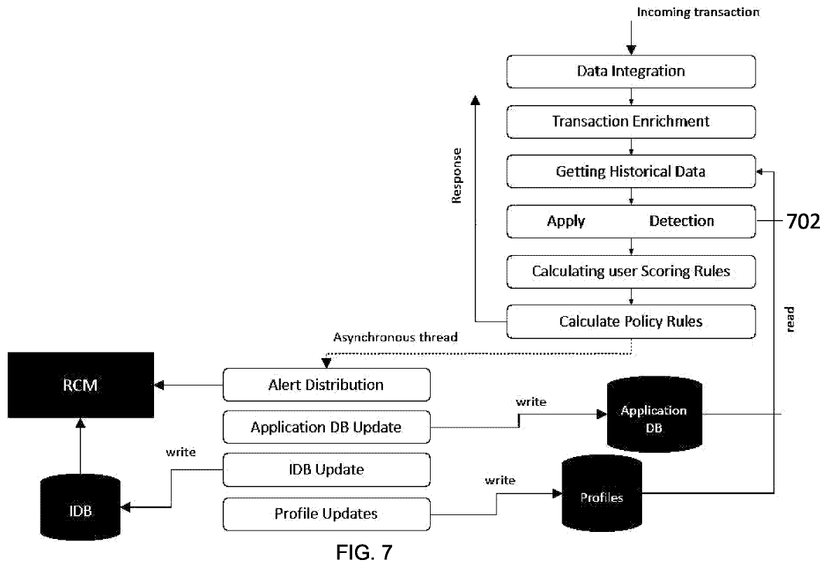

FIG. 7 shows a high level representation of an example process for mitigating catastrophic forgetting as embedded in an example system for fraud detection according to some embodiments of the invention. In one nonlimiting example system and process, some or all of the protocols and procedures described herein may be implemented in step 702 and may be preceded or followed by additional operations—including, for example, filtering data points based on, e.g., custom events and activities; and/or adjusting prediction scores based on indicative features such as, e.g., further described herein, as well as various calculations and/or data collection and/or processing operations. In some embodiments, additional steps such as alert distribution, and/or database update steps, and/or various additional processing steps known in the art, may be included and, for example, follow some of the protocols and procedures described herein.

A detection flow according to some embodiments may include multiple steps, such as for example: data fetching for detection (detection period sets and profile data for relevant entities), variable calculations, and analytics platform and/or model operations including, e.g., generating or providing different indicative features, and SMO (structured model overlay) as further discussed herein.

Transaction variables—which may for example be considered by the online model in generating or outputting prediction or classification scores such as, e.g., described herein—may be defined and extracted, in some embodiments, with reference to a corresponding “context”. For example, a transaction variable of “amount” (e.g., the dollar amount of a transaction) may be extracted with additional context information such as for example an identifier of the transaction, the history or historical data items of the main entity associated with the transaction (which may be, e.g., a client or account associated with an identifier as known in the art). It should be noted that various variables attributed to data points (which, as noted herein, may be unrelated to financial transactions) and different metadata or contexts relating to such data points and variables may generally be selected or chosen and be used or considered in different embodiments of the invention.

In some embodiments, variables may by defined or set manually, such as for example by a human operator, analyst, or subject matter expert (SME). The variables may be exported to, and/or documented, an event log such as for example a detection log, stored in a database, and be exposed or provided to users in user analytics contexts, e.g., using appropriate analytics platforms and/or graphical user interfaces.

It should be noted that different variable and/or parameter choices may be included in different embodiments of the invention and in the various protocols or procedures considered herein. It may be realized that different variables may be considered relevant in different arts and/or scientific or technological fields (as different variables may be considered or found statistically significant in one field, and insignificant in another).

In some embodiments of the invention, transaction variables may be used to create custom events and/or new indicative features, which may for example be used to gather or select data points which should be examined or classified by the system such as, e.g., described herein—as well as to weigh or normalize results calculated by the online model such as, e.g., described herein.

In one example, transactions that satisfy certain criteria may correspond to events or custom events that may be, for example, of interest to an analyst and that may for example be chosen or selected for a fraud detection process, or for additional or alternative processes involving protocols and procedures for mitigating catastrophic risk such as, e.g., described herein. An analyst may define variables or events the system may identify and then profile or document, when processing a transaction matching or satisfying the relevant criteria. Variables and events may be used to create indicative features (using a custom indicative features mechanism which may for example be manually defined by a user or analyst, or using a structured model overlay (SMO) mechanism as further discussed herein).

For example, an analyst may define an event defining criterion that says: amount >$100,000. The system may then profile, document, or group aggregations for all transactions that “trigger” this event, or that satisfy this criterion. For example: embodiments of the invention may automatically create groups, aggregations, or profiles transactions of an amount larger than $100,000, which may include, e.g., a group of first such transactions for a given transaction party or client, a group of transactions involving a given party such as for example a specific bank, and the like, using various feature detection protocols and procedures. Various additional or alternative procedures, as well as conditions or criteria for profiling data points or transactions are known in the art and may be used in different embodiments.

A structured model overlay (SMO) as used herein may refer to a framework or system in which an analyst may receive outputs which may be automatically provided by an analytics platform (which may be or may include, e.g., relevant transaction variables, custom events and their definitions, and/or indicative features such as for example described herein) as suggestions or inputs to enhance the detection or profiling results, or to generate findings of interest for setting or adjusting the transaction's risk score (which may be calculated, e.g., using the online model such as for example described herein or using an additional or different, default model which may be part of the relevant analytics platform).

For example, once custom events are defined, an analyst or SME may use predefined indicative feature templates (which may, e.g., be suggested or provided by an analytics or fraud detection platform such as for example described herein) to enrich or revise model results with indicative features, e.g., for adjusting or updating model scores such. Following the same example, an analyst may use an indicative feature template which may be, e.g., automatically suggested by an analytics platform (e.g., the NICE Actimize IFM-X platform, or a different platform or software suite) and create an indicative feature that says that if it has been more than a year since the customer performed a transaction with an amount greater than $100,000, then 10 points may be added to the overall risk score for that transaction (where the risk score may be calculated, e.g., by a machine learning model such as for example described herein, or by additional or alternative procedures as known in the art), and if not—then, e.g., no extra points may be added. In other words, indicative features may be defined and used based on custom events (e.g., for a custom event Cl defined as: “amount >$100,000”, an indicative feature requiring the addition of +10 points for classifications scores calculated for transactions satisfying Cl may be used). In this context, it should be noted that various indicative feature templates are known in the art and/or are included in various analytics platforms, and may be used in different embodiments of the invention.

It should be noted that various feature extraction and/or engineering approaches are known in the art and may be used, for example, to create different indicative features using various transaction variables as part of different embodiments of the invention. In addition, various analytics platforms and graphical user interfaces may be used in different embodiments.

A detection log may be produced or provided by embodiments of the invention—which may contain transactions enriched or combined with analytics data such as indicative features, results, and variables. A user or analyst may thus configure or selected what data and/or variables should be exported to the log and use it, e.g., for pre- and post-production tuning including, e.g., adjusting prediction scores by the online model such as for example described herein. Various log file formats are known in the art and may be used in different embodiments.

In some embodiments, protocols and procedures such as for example disclosed herein, as well as various analytics logic operations (which may refer to, e.g., processing and/or generating of transaction variables, custom events, and/or indicative features, and the like) may be implemented in two (or multiple) phases, where only a subset of the transactions goes through the second phase, as for example determined by a filter (or a plurality of filters).

In some embodiments, a process (such as for example a fraud detection process) may be triggered for each data point (or transaction). However, in the nonlimiting example of transactions—since analytics logic may relate to entities (such as, e.g., parties involved in a transaction) rather than transactions themselves—specific transactions for the same entity or party may trigger a detection processes, while the detection logic may be based on the party's activity in a relevant detection period. For example, a transaction exceeding a predetermined threshold of $100,000 may trigger a detection process taking into account all transactions of the relevant credit card owner which took place within the present calendar month. In this context, tags, activities, or base activities (see further discussion herein) may also be specified as process triggering events. It should be noted that different triggering events and/or detection periods, as well as additional or alternative detection processes or workflows may be used in different embodiments of the invention.

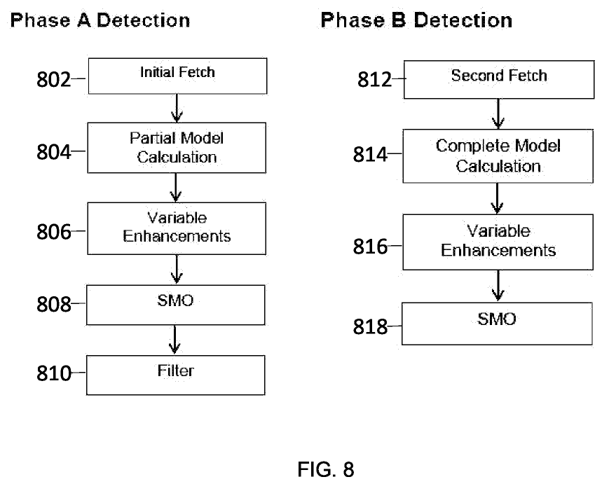

FIG. 8 is a flowchart of an example fraud detection process according to some embodiments of the invention.

In some embodiments of the invention, a detection flow for transactions may be divided into two phases, phase A and phase B. This may be desirable for performance and/or algorithmic flexibility and adaptability considerations. In one example, analytics logic may run after phase A, for example to decide whether it is necessary to run phase B. A decision not to proceed to phase B may be, e.g., because the transaction may already be found or marked as suspicious (or as not suspicious) in phase A. If it is not yet clear if the transaction is suspicious or not, the detection process may continue to phase B.

Different example steps or subprocesses may be or may include:
Initial Fetch 802: may fetch the profiles and data needed for the fraud detection process (which may correspond to a predefined or period such as for example one calendar month); some embodiments may, for example, fetch card profiles and device profiles and the previous activity by, e.g., a set of credit cards. The fetched data may be collected and used by embodiments of the invention and/or by relevant systems in which some embodiments may be implemented, such as for example described in detail herein.
Partial Model Calculation 804: may calculate or suggest custom events and indicative features. This may be performed, for example, using the Actimize Analytics framework provided as part of the Actimize IFM-X platform—to include both internal or default indicative features and indicative custom features which may be manually defined by a user. This step may also include calculating or determining a risk score such as for example the Actimize Analytics risk score provided as part of the Actimize IFM-X platform (it should again be noted that additional or alternative platforms and corresponding analytics frameworks may be used in different embodiments, and that the framework considered herein is merely a nonlimiting example).
Variable Enhancements 806: may suggest and/or provide indicative features based on the variables provided in previous steps.
SMO 808: In some embodiments, this may be or may include an exit point or application programming interface (API) using which an SMO system or component may be for example interacting with third party or external models or platforms (which may not be included in the Actimize IFM-X platform considered as a nonlimiting example herein), and requesting their suggestions for indicative features—e.g., based on the variables and/or custom events and/or features already used within the Actimize environment (e.g., as discussed with regard to 804).
Indicative features provided at this step may override, e.g., the Actimize Analytics features used in previous steps and accordingly impact the calculated risk score. Various integration workflows are known in the art and may be included in different embodiments of the invention. The SMO component may then recommend or make a determination as to whether or not to proceed to phase B, although a dedicated filter component may make the final decision in some embodiments as further described herein.
Filter 810: may be used to decide whether to perform phase B detection based on various conditions or criteria, which may include risk scores calculated or generated as described herein, as well as additional or alternative conditions or criteria which may be manually defined or used as default options in the relevant analytics platform. In some embodiments, the filter may have multiple parts or subcomponents, representing, e.g., custom or manually defined filtering criteria, criteria which may be received from third party platforms or components, and the like. An exit point or API may implement the filter (which may for example be provided by a third party or component such as for example described herein regarding SMO elements). Additional or alternative filtering components may be included in different embodiments.
Second Fetch 812: may include an additional data retrieval based on, e.g., dedicated database queries which may be more computationally complex or costly compared to ones used in Initial Fetch 802 (it may, for example, return only results including multiple payees per transaction on top of the results provided in previous steps).
Complete Model Calculation 814: may calculate or generate more indicative features and perform additional calculations which may not, e.g., be included in Partial Model Calculation 804.
Variable Enhancements 816: may perform more calculations and/or processing operations (e.g., to provide additional indicative features), for example based on features and/or variables newly retrieved or provided in previous steps such as for example Second Fetch 812.
SMO 818: may decide or determine a final score for the transaction based on one or more of all available variables, events, and indicative features. This may include or be based on additional components or models, as well as on additional conditions or criteria.
   It should be noted that additional or alternative fraud detection processes and corresponding algorithmic flows may include multiple phases and may be used in different embodiments of the invention, e.g., for achieving a desirable computational cost-to-performance ratio.

Some embodiments of the invention may include a classification or tagging of data points or input data considered in the protocols or procedures described herein into “activities” or “base activities”. Some embodiments may run or execute the various protocols or procedures described herein on data points corresponding to specific tags, activities, or base activities.

“Activities” as used herein may refer to an approach or framework for logically grouping events in the client's systems. For example, each channel or channel type (e.g., “wired internet connection”, “cellular network”, and the like) using which a transaction may be performed may define, may correspond to, or may constitute an activity (for example, a “Web activity”). In another example, each type of service may be or may correspond to an activity, for example, an “internal transfer” activity. In another example, combinations of an activity and a type of service may also be an activity, e.g., “web internal transfer” activity.

Some activities may span multiple channels and services, for example, a transfer activity, which may correspond to or describe any activity that results in a transfer. In some embodiments transactions may be categorized or be associated with multiple activities.

Some embodiments of the invention may include or involve calculating “base activities”. In one example, activities may be divided into multiple base activities. Base activities may represent, for example, a customer's most representative or “archetypal” activity pattern, which may determine which detection models or workflow and/or which thresholds, conditions or criteria, as well as different parameters considered herein, may be used or calculated. In some embodiments, each transaction may be mapped or attributed to a single base activity, and a detection model or workflow may be assigned or matched with each transaction. In one example, a default base activity may be determined according to the channel, transaction type, additional fields, and calculations. In another example, a base activity may be determined based on the plurality of activities to which a transaction may be attributed (and may be set, for example, as the activity most prevalent or common among the plurality of activities associated with that transaction and as recorded or calculated for a given user over a given time period).

In some embodiments, such as for example ones integrated into the Actimize IFM-X platform mentioned herein—the base activity of a transaction may be set by combining, e.g., a channel type and a transaction type as mapped or documented, e.g., in a dedicated data integration component (see, e.g., FIG. 3 and corresponding discussion herein). For example, for a user involved in a transaction as an “acquirer” or buyer, a base activity may be calculated based on combining a “channel type”, a “message type”, and additional fields relevant to such a transaction type as provided by the Actimize IFM-X platform considered as a nonlimiting example herein.

Various protocols or procedures for determining or calculating tags, activities, or base activities, for a given data point or transaction may be realized by one skilled in the art and may be used in different embodiments. Additional or alternative protocols and/or procedures for determining a fraud detection process or workflow for a given data point or transaction, a plurality of transactions, a related user or entity, and the like, may be included in different embodiments.

Embodiments of the invention may improve previous systems and methods by allow to mitigate or overcome catastrophic forgetting, being one of the longstanding hurdles or problems in machine learning technologies. Embodiments may allow for creating AI systems that may thus “learn” more analogously to humans—that is, in an incremental and cumulatively manner—without the fear of losing valuable past knowledge or information. Embodiments of the invention may enhance the robustness and applicability of machine learning and AI systems when used to solve various problems across different and diverse scientific and technological domains.

Some embodiments of the invention may improve previous AI or ML technologies by addressing the practical limitations of storing large volumes of historical data and privacy concerns associated with storing such volumes of data. Using generative models to synthesize past data, some embodiments of the invention may circumvent the need for direct storage, which can also ameliorate privacy concerns (e.g., if the relevant historical data is sensitive or classified).

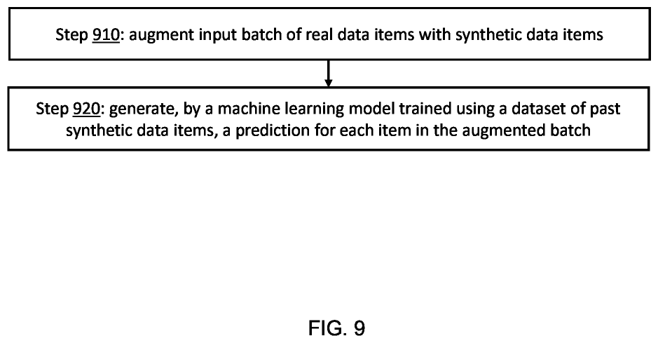

FIG. 9 is a flow diagram of an example method for mitigating catastrophic risk according to some embodiments of the invention. In step 910, embodiments of the invention may augment an input batch including a plurality of real data items, with a plurality of synthetic data items-such as for example described herein. Embodiments may then generate, using a machine learning model (which may be a first machine learning model among a plurality of machine learning models, e.g., an online classifier model) a prediction for each data item in the augmented batch (step 920). In some embodiments, the machine learning model may be trained using a dataset of synthetic data items (or past synthetic data items)—while for example another, different machine learning model (such as for example a GenAI model used for generating synthetic data items) may be trained using real data items—such as for example discussed herein. Additional or alternative workflows for mitigating forgetting in computer models according to different embodiments of the invention may be realized.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for mitigating forgetting in a machine learning model, the method comprising:
augmenting an input batch of one or more real data items with one or more synthetic data items; and
generating, by a first machine learning model, a prediction for each data item in the augmented batch, the first machine learning model trained using a dataset of past synthetic data items.

2. The method of claim 1, comprising generating, by a second machine learning model, one or more of the synthetic data items based on the input batch, the second machine learning model trained using a dataset of past real data items.

3. The method of claim 1, wherein the augmenting comprises, for each synthetic data item:
if the synthetic data item corresponds to a plurality of statistical properties, adding the synthetic data item to the augmented batch, wherein the statistical properties describe the input batch.

4. The method of claim 2, comprising, for each synthetic data item:
mapping a correspondence between the synthetic data item and one or more of the real data items in the input batch; and
adjusting the augmenting of the input batch based on the mapping and based on at least one of: the dataset of past synthetic data items, and the dataset of past real data items.

5. The method of claim 2, comprising:
learning a distribution of an updated dataset of past real data items; and
retraining the second machine learning model based on the distribution.

6. The method of claim 1, wherein the first machine learning model is optimized using a stochastic gradient descent (SGD) algorithm and a logarithmic loss function.

7. The method of claim 2, wherein the second machine learning model comprises: a generative adversarial network, and a variational autoencoder.

8. The method of claim 1, comprising: prior to the generating of a prediction for each data item in the augmented batch, training the first machine learning model until a minimum required performance level is achieved.

9. The method of claim 2, wherein the generating of at least one of the predictions by the first machine learning model and the generating of at least one of the synthetic data items by the second machine learning model are performed concurrently.

10. The method of claim 1, wherein the prediction comprises a score, and wherein the method comprises:
if the score exceeds a threshold, transmitting an alert to a remote computer system over a communication network.

11. A computerized system for mitigating forgetting in a machine learning model, the system comprising:
a memory,
and a computer processor configured to:
augment an input batch of one or more real data items with one or more synthetic data items; and
generate, by a first machine learning model, a prediction for each data item in the augmented batch, the first machine learning model trained using a dataset of past synthetic data items.

12. The computerized system of claim 11, wherein the processor is to generate, by a second machine learning model, one or more of the synthetic data items based on the input batch, the second machine learning model trained using a dataset of past real data items.

13. The computerized system of claim 11, wherein the augmenting comprises, for each synthetic data item:
if the synthetic data item corresponds to a plurality of statistical properties, adding the synthetic data item to the augmented batch, wherein the statistical properties describe the input batch.

14. The computerized system of claim 12, wherein the processor is to:
for each synthetic data item:
map a correspondence between the synthetic data item and one or more of the real data items in the input batch; and
adjust the augmenting of the input batch based on the mapping and based on at least one of: the dataset of past synthetic data items, and the dataset of past real data items.

15. The computerized system of claim 12, wherein the processor is to:
learn a distribution of an updated dataset of past real data items; and
retrain the second machine learning model based on the distribution.

16. The computerized system of claim 11, wherein the first machine learning model is optimized using a stochastic gradient descent (SGD) algorithm and a logarithmic loss function.

17. The computerized system of claim 12, wherein the second machine learning model comprises: a generative adversarial network, and a variational autoencoder.

18. The computerized system of claim 11, wherein the processor is to:
prior to the generating of a prediction for each data item in the augmented batch, train the first machine learning model until a minimum required performance level is achieved.

19. The computerized system of claim 12, wherein the generating of at least one of the predictions by the first machine learning model and the generating of at least one of the synthetic data items by the second machine learning model are performed concurrently.

20. The computerized system of claim 11, wherein the prediction comprises a score, and wherein the processor is to:
if the score exceeds a threshold, transmit an alert to a remote computer system over a communication network.
